(19) United States
(12) Patent Application Publication
(10) Pub. No.: US 2024/0206017 A1
(43) Pub. Date: Jun. 20, 2024

(54) TEMPERATURE CONTROL APPARATUS AND TEMPERATURE CONTROL METHOD

(71) Applicant: SEMES CO., LTD., Cheonan-si (KR)

(72) Inventors: Sanghyon JEON, Cheonan-si (KR); Ikho LEE, Yongin-si (KR); Dongok AHN, Anyang-si (KR)

(73) Assignee: SEMES CO., LTD., Cheonan-si (KR)

(21) Appl. No.: 18/539,966

(22) Filed: Dec. 14, 2023

(30) Foreign Application Priority Data
Dec. 15, 2022 (KR) 10-2022-0176115

(51) Int. Cl. H05B 1/02

(52) U.S. Cl. CPC H05B 1/0288

(57) ABSTRACT

A temperature control apparatus includes a heater of which a temperature increases in response to receiving power, a power source supplying alternating current (AC) power to the heater, a temperature sensor sensing the temperature of the heater and outputting a measured temperature value, and a controller controlling the power supply to the heater so that the heater follows a set temperature profile, wherein the controller supplies the power to the heater for first one control period in a variable period consisting of a plurality number of times of control periods (on duty), and stops the power supply to the heater during remaining control periods until the variable period is finished (off duty).

### CROSS-REFERENCE TO RELATED APPLICATION

This application is based on and claims priority under 35 U.S.C. § 119 to Korean Patent Application No. 10-2022-0176115, filed on Dec. 15, 2022, in the Korean Intellectual Property Office, the disclosure of which is incorporated by reference herein in its entirety.

### BACKGROUND

### 1. Field

The disclosure relates to a temperature control apparatus and method capable of controlling a temperature of a heater or a cooler, and more particularly, to a temperature control apparatus and method for controlling a temperature of a heater or a cooler included in semiconductor manufacturing equipment to follow a set temperature profile.

### 2. Description of the Related Art

The role of semiconductor devices has become more and more important in the information society with the recent rapid spread of information media. Also, semiconductor devices are widely used in various industrial fields. A method for manufacturing a semiconductor device includes a process of heating a substrate and a process of cooling the substrate.

According to the related art, a phase angle control method and a pulse width modulation (PWM) control method have been used as temperature control methods.

The phase angle control method is a method of controlling output power by turning on a control signal at a phase angle suitable for an output that is necessary for a set temperature and turning off the control signal at 0 point thereafter. Although the phase angle control method has excellent precision in controlling the temperature because an output power value may be continuously changed and there is no limitation in setting the output power value, radio frequency and noise are generated and a load may be applied on a semiconductor manufacturing apparatus. Thus, durability of the manufacturing apparatus may degrade, and reactive power may be generated which causes power loss.

The PWM method is a method of controlling output power by switching to required output power for a certain period, and according to the required output, a duty cycle that is a ratio of switch-on in one period varies. Because the control signal is changed at 0 point according to the PWM method, radio frequency and noise do not occur, and a voltage and a current have the same phase, which minimizes reactive power. PWM methods may be classified into a fixed-period control type and a variable-period control type. In the case of the fixed-period control, a control period is long, and thus, a response speed is decreased and precision in controlling a temperature degrades. In the case of the variable-period control, precise control of power and temperature may be possible as compared with the fixed-period control, but there is a limitation in the number of variable periods, and thus, the control precision is decreased as compared with the phase angle control method.

Therefore, a temperature control apparatus and method capable of reducing radio frequency and noise and reducing reactive power while securing precision in temperature control need to be developed.

### SUMMARY

Provided are a temperature control apparatus and method capable of reducing noise caused by radio frequency output and damage to durability of the apparatus.

Provided are a temperature control apparatus and method capable of reducing reactive power of a heater or a cooler and maximizing power efficiency.

Provided are a temperature control apparatus and method capable of controlling a temperature of a heater or a cooler with high precision.

It will be appreciated by one of ordinary skill in the art that that the objectives and effects that could be achieved with the disclosure are not limited to what has been particularly described above and other objectives of the disclosure will be more clearly understood from the following detailed description.

Additional aspects will be set forth in part in the description which follows and, in part, will be apparent from the description, or may be learned by practice of the presented embodiments of the disclosure.

According to an aspect of the disclosure, a temperature control apparatus includes a heater of which a temperature increases in response to receiving power, a power source configured to supply alternating current (AC) power to the heater, a temperature sensor configured to sense the temperature of the heater and output a measured temperature value, and a controller configured to control the power supply to the heater so that the heater follows a set temperature profile, wherein the controller is further configured to supply the power to the heater for first one control period in a variable period consisting of a plurality number of times of control periods (on duty), and stop the power supply to the heater during remaining control periods until the variable period is finished (off duty).

The controller may be further configured to calculate a required output that is a ratio of an output required for the temperature of the heater to reach the set temperature with respect to a maximum output of the power, and a variable period value that is a total number of times that the control period may be repeated during the variable period and may be calculated as an integer obtained by rounding up a reciprocal of the required output.

The controller may include a processor configured to perform calculations, and a memory storing data, and the processor may be further configured to calculate a reciprocal of the variable period value as the control output, calculate a value obtained by subtracting the control output from the required output as an insufficient output, and the memory may store the insufficient output, and in a next variable period repeated after finishing the variable period, a new required output may be calculated based on the insufficient output stored in the memory.

The processor may be further configured to calculate a proportional-integral-differential control (PID) control value based on a difference between the set temperature and a measured temperature, and calculate a new required output by integrating the stored insufficient output based on the PID control value.

The controller may include a zero-cross detector (ZCD) that outputs a zero-cross signal when an intensity of the AC voltage from the power source is 0 and a processor performing calculations, the control period may be determined as a time period from a time when receiving a zero-cross signal to a time when receiving next zero-cross signal, and the processor may be configured to determine whether the power supply status with respect to the heater is changed when receiving the zero-cross signal from the ZCD.

The temperature control apparatus may further include a heater power switch that supplies the power or blocks the power supply to the heater by receiving a control signal from the controller, wherein the heater power switch is a solid-state relay (SSR).

The processor may be configured to calculate control outputs, variable period values, and insufficient outputs corresponding to a plurality of required outputs in advance and store the calculated values in the memory, and load from the memory and use the control output, the variable period value, and the insufficient output corresponding to the required output that is required according to the repetition of the variable periods.

The control period may be 0.5 times greater than a period of the AC voltage from the power source.

According to an aspect of the disclosure, a temperature control apparatus includes a cooler of which a temperature decreases in response to receiving power, a power source configured to supply alternating current (AC) power to the cooler, a temperature sensor configured to sense the temperature of the cooler and output a measured temperature value, and a controller configured to control the power supply to the cooler so that the cooler follows a set temperature profile, wherein the controller is further configured to supply the power to the cooler for first one control period in a variable period consisting of a plurality number of times of control periods (on duty), and stop the power supply to the cooler during remaining control periods (off duty), and calculate a required output that is a ratio of an output required for the temperature of the cooler to reach the set temperature with respect to a maximum output of the power, wherein the number of times of the control periods included in the variable period is calculated as an integer obtained by rounding up a reciprocal of the required output.

According to an aspect of the disclosure, a temperature control method in a temperature control apparatus which controls a power supply to a heater during a variable period consisting of a plurality number of times of control periods, so that the heater follows a set temperature, includes a period count step in which a period count value that is the number of times that the control period is repeated with a variable period value that is a total number of times that the control period is repeated during the variable period, a period update step, in which the period count value is updated to 0 when the period count value is greater than or equal to the variable period value in the period count step, and a switch-on step, in which a switch-on signal for supplying power to the heater is transmitted to a heater power switch after setting the period count value as 0 in the period update step.

The temperature control method may further include finishing a period, in which a value obtained by adding 1 to the period count value after the turning-on of the switch is stored as a new period count value.

The temperature control method may further include an initial period determination step in which, when the period count value is less than the variable period value in the period counting step, it is determined whether the period count value is 1, and a switch-off step in which, when the period count value is 1 in the initial period determination step, a switch-off signal for blocking the power supply to the heater is transmitted to the heater power switch.

The temperature control method may further include finishing a period, in which a value obtained by adding 1 to the period count value after the turning-off of the switch is stored as a new period count value.

The temperature control method may further include an initial period determination step in which, when the period count value is less than the variable period value in the period count step, it is determined whether the period count value is 1, and a period ending step in which, when the period count value is not 1 in the initial period determination step, a value obtained by adding 1 to the period count value is stored as a new period count value.

The temperature control method may further include a proportional-integral-differential control (PID) step in which a PID control value is calculated based on a difference between a measured temperature detected by a temperature sensor measuring the temperature of the heater and the set temperature, after updating the period count value to 0 in the period update step, and a required output calculation step, in which the required output that is a ratio of an output required for the temperature of the heater to reach the set temperature with respect to a maximum output of the power source is calculated based on the PID control value calculated in the PID step.

The temperature control method may further include a variable period/control output calculation step in which, based on the required output calculated in the required output calculation step, a value obtained by rounding up a reciprocal of the required output value is set as the control output and a value obtained by rounding up a reciprocal of the required output is set as the variable period value.

The temperature control apparatus may further include a memory for storing data, and in the switch-on step, a value obtained by subtracting the control output from the required output may be stored as an insufficient output in the memory.

The temperature control method may further include a zero-cross signal sensing step in which a zero-cross signal indicating that a voltage of the power source is 0 is sensed, wherein, when the zero-cross signal is sensed in the zero-cross signal sensing step, the period count step is executed.

When the period count value is updated to 0 in the period update step and a new variable period starts, in the required output calculation step, a new required output value is calculated based on the insufficient output value and the PID control value provided that there is the insufficient output value stored in the memory in a previous variable period.

According to an aspect of the disclosure, a temperature control method used by a temperature control apparatus to control a power supply to a cooler during a variable period consisting of a plurality number of times of control periods and cools down the cooler, so that the cooler follows a set temperature, includes a period count step in which a period count value that is the number of times that the control period is repeated with a variable period value that is a total number of times that the control period is repeated during the variable period, a period update step, in which the period count value is updated to 0 when the period count value is equal to or greater than the variable period value, a switch-on step, in which a switch-on signal for supplying power to the cooler is transmitted to a cooler power switch after setting the period count value as 0 in the updating of the period, an initial period determination step in which, when the period count value is less than the variable period value in the period counting step, it is determined whether the period count value is 1, and a switch-off step in which, when the period count value is 1 in the initial period determination step, a switch-off signal for blocking the power supply to the cooler is transmitted to the cooler power switch.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a circuit diagram for describing heater control used in semiconductor manufacturing equipment according to the related art;

FIG. 2 is a graph for illustrating pulse width modulation (PWM) control according to the related art;

FIG. 3 is a graph for illustrating phase angle control according to the related art;

FIG. 4 is a graph for illustrating generation of noise due to a phase angle control method according to the related art;

FIG. 5 is a diagram for describing a temperature control apparatus according to an embodiment of the present disclosure;

FIG. 6 is a diagram for describing a zero-cross signal-based operation of a temperature control apparatus according to an embodiment of the present disclosure;

FIG. 7 is a diagram for describing supplying 10% output to a heater according to a temperature control method according to an embodiment of the present disclosure;

FIG. 8 is a diagram for describing supplying 60% output to a heater according to a temperature control method according to an embodiment of the present disclosure;

FIG. 9 is a table for illustrating an example of a control output and variable period in a temperature control method according to an embodiment of the present disclosure; and

FIG. 10 is a flowchart for describing a temperature control method according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects of the description. As used herein, the term “and/or” includes any and all combinations of one or more of the associated listed items. Expressions such as “at least one of,” when preceding a list of elements, modify the entire list of elements and do not modify the individual elements of the list.

Hereinafter, one or more embodiments of the disclosure will be described in detail with reference to accompanying drawings. Embodiments of the disclosure are non-limiting, and thus the scope of various aspects of the disclosure should not necessarily be limited by any particular characteristics of the provided embodiments. Rather, these embodiments are provided so that this disclosure will be thorough and complete, and will fully convey the disclosure to one of ordinary skill in the art.

In the description, certain detailed explanations of the related art are omitted when it is deemed that they may unnecessarily obscure the essence of the disclosure. In addition, the accompanying drawings are not shown according to the actual scale to help understand the invention, but the dimensions of some components may be exaggerated.

In the following description, when it is described that a component is connected to another component, it may be directly connected to other components, but a third component may be interposed therebetween. Similarly, when it is described that a component exists on another component, it may be directly formed on another component, or a third component may be present therebetween.

In addition, the structure or size of each component is exaggerated for the convenience and clarity of each component, and parts that are not related to the description are omitted. Like reference numerals denote the same elements on the drawings, and detailed descriptions thereof are omitted. In addition, the terms used herein are used only explaining the disclosure, not used to limit the scope of the disclosure described in the claims.

Unless otherwise defined, all terms (including technical and scientific terms) used herein have the same meanings as commonly understood by one of ordinary skill in the art to which this invention belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

The terms used in the present specification are merely used to describe particular embodiments, and are not intended to limit the present disclosure. An expression used in the singular encompasses the expression of the plural, unless it has a clearly different meaning in the context. In the specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In description of the disclosure, the terms “first” and “second” may be used to describe various components, but the components are not limited by the terms. For example, a second element may be referred to as a first element while not departing from the scope of the disclosure, and likewise, a first element may also be referred to as a second element. The term “and/or” includes a combination of a plurality of related described items or any one item among the plurality of related described items.

Hereinafter, embodiments of the disclosure are described in detail with reference to accompanying drawings.

The disclosure relates to a temperature control apparatus and method for controlling a temperature of a heater included in semiconductor manufacturing equipment, and according to the temperature control apparatus and method in the semiconductor manufacturing equipment, the temperature of the heater may be precisely controlled during heating or cooling process of a semiconductor substrate (or wafer), degradation in durability of the equipment due to radio frequency and noise may be prevented, and the power efficiency may be increased by reducing reactive power.

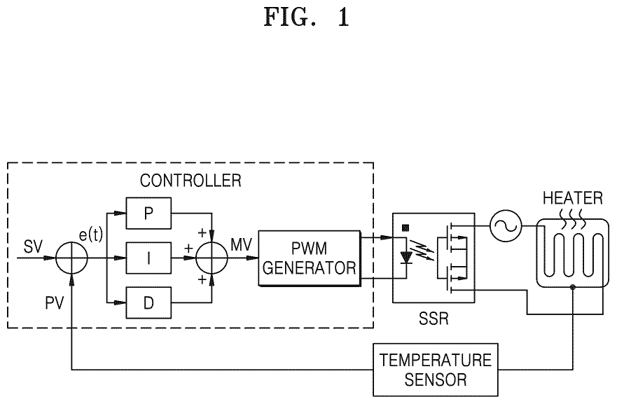

FIG. 1 is a circuit diagram for describing heater control used in semiconductor manufacturing equipment according to the related art. Heater control in semiconductor manufacturing equipment according to the related art is described below with reference to FIG. 1.

A solid-state relay (SSR) may be used as a power switch for controlling the power of the heater in the semiconductor equipment. A controller for controlling the temperature of the heater in the semiconductor equipment may control an output of power applied to the heater by controlling the SSR. Turning-on/off control may be performed with respect to the SSR. The turning-on/off control denotes a control method in which the controller transfers an output signal to the SSR and the SSR turns on/off the heater according to the output signal.

As a turning-on/off control method of the SSR according to the related art, pulse width modulation (PWM) control in which the output power is switched on/off with a cycle of 1 to 2 seconds has been mainly used. According to the PWM control, the power is switched on/off according to a required output to supply the power at a constant cycle. Therefore, a duty ratio that is a ratio of switch-on time with respect to one cycle varies depending on the required output power.

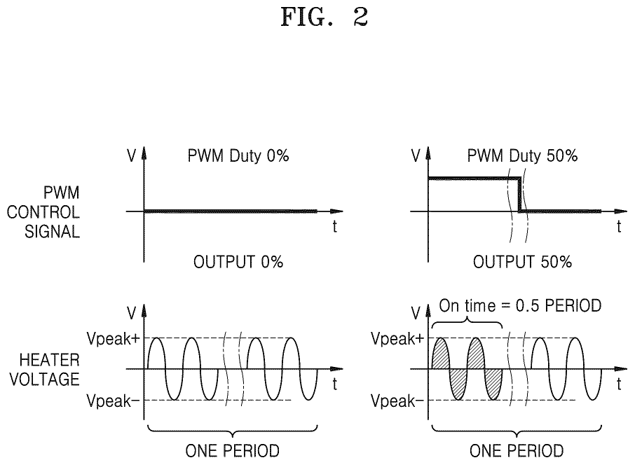

FIG. 2 is a graph for illustrating pulse width modulation (PWM) control according to the related art.

In the PWM control method, a supply of power to the heater is controlled by changing the duty ratio of the output with a relatively long cycle of a few to hundreds of seconds. A zero-cross detector that senses a zero-point of the output may be used to perform the PWM control method. The PWM control method using the zero-cross detector switches on/off the output power only at the zero point of the voltage (or current), and thus, the phases of the voltage and current are the same. Accordingly, noise is generated less and there is little reactive power, and thereby improving the power efficiency.

FIG. 2 shows an example in which outputs at 0% and 50% of a maximum output are controlled through the PWM control according to the related art. Referring to FIG. 2, when the output is 0%, a PWM control signal is maintained to be 0, and a voltage supplied to the heater is maintained to be 0. When the output is 50%, the PWM control signal is switched on only during 0.5 period in one period and switched off in remaining period, and the voltage supplied to the heater is also turned on only during 0.5 period.

However, in the PWM control method, the control period is long and the switching-on/off may be changed only at the zero point, and thus, the switch may not be controlled at the portion other than the zero point. Thus, the controlling may not be smoothly performed and the precision in the heater control may not be sufficient, and thereby degrading temperature control stability of the heater. Also, when the control period is reduced, an output resolution decreases.

That is, according to the PWM control method, issues caused by the radio frequency and noise may not occur, but the heater temperature may not be precisely controlled and the precision in heater control may degrade.

In order to address the issues in the PWM control method with respect to the SSR according to the related art, a phase angle control method utilizing random SSR, a silicon controlled rectifier (SCR), or a triode for alternating current (TRIAC) switch may be used. The phase angle control method is a method of controlling supplied power to the heater by repeatedly turning on an output signal at a phase angle suitable for the required output and turning off the output signal at a next zero-cross timing in each period.

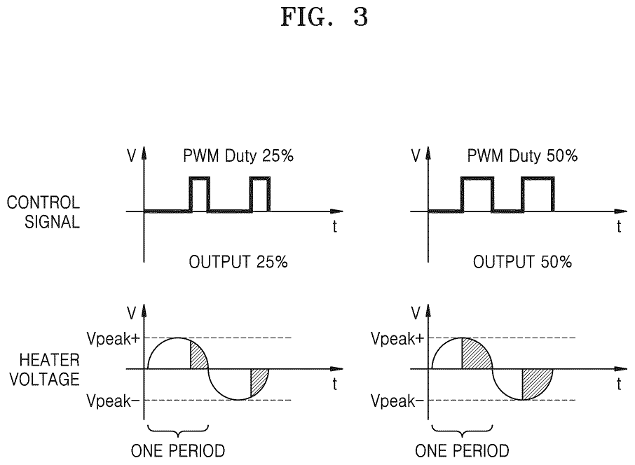

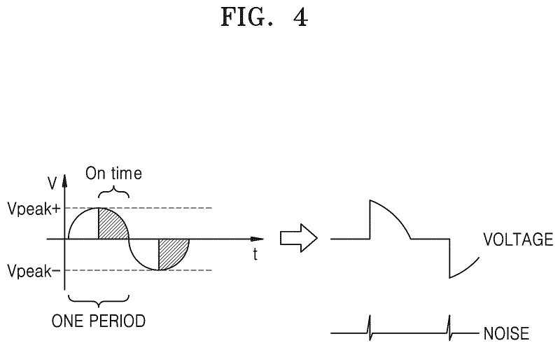

FIG. 3 is a graph for illustrating phase angle control according to the related art. FIG. 4 is a graph for describing generation of noise due to a change in an output according to the phase angle control method of the related art.

One period of the phase angle control may correspond to 0.5 or 1 period of an alternating current (AC) power, and the switch turning-on/off may be changed even when the output is not the zero point. Thus, the output intensity of the supply power may be freely changed at necessary point in time, and the phase angle control may be superior to the PWM method in view of the precision and stability of control. In the example shown in FIGS. 3 and 4, it is shown that one period of the phase angle control is 0.5 period of the AC power.

FIG. 3 shows an example in which outputs at 25% and 50% of a maximum output are controlled through the phase angle control according to the related art. Referring to FIG. 3, when the output is 25%, the PWM control signal is switched on at 0.75 period and switched off at next zero point repeatedly. In addition, when the output is 50%, the PWM control signal is switched on at 0.25 period and switched off at next zero point repeatedly.

However, according to the phase angle control method, noise is generated due to the radio frequency, the lifespan of devices such as the heater, the SSR, etc. is reduced, and there is a concern of wrong operations. Referring to FIG. 4, noise occurs at a point in time when the switch is turned on. The noise is generated due to the radio frequency/high voltage operations, and becomes problematic when the output is controlled to be 30% to 70% of the maximum output.

Moreover, during turning-off in the half period of the output, the phase of current lags behind the phase of the voltage, and accordingly, the reactive power is generated and there is loss in the power, and thereby increasing costs. In addition, the noise caused by the radio frequency may badly affect condenser equipment for compensating for the reactive power.

According to the temperature control apparatus and method of the various embodiments of the disclosure, the issues of the heater control method according to the related art as described above may be addressed, and advantages are increased.

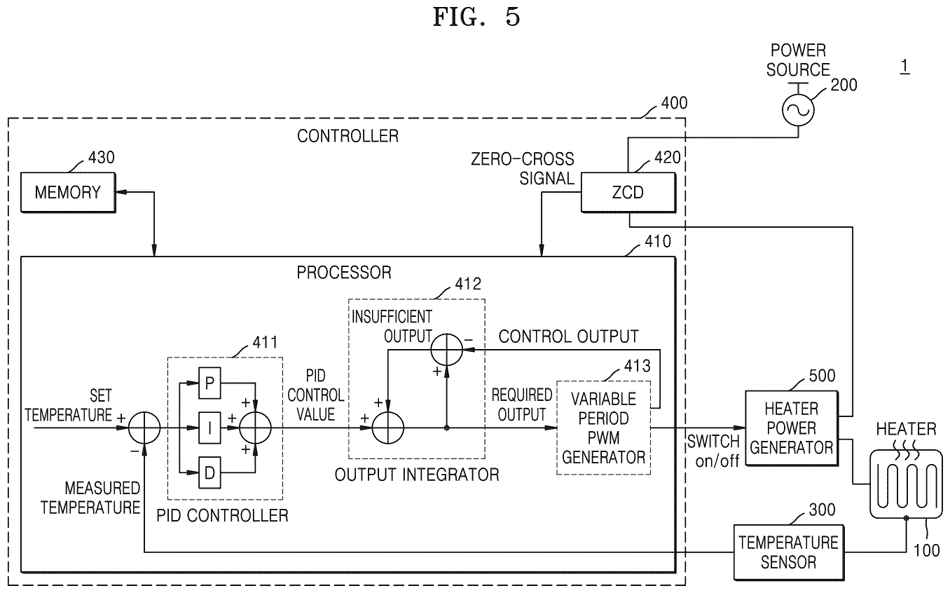

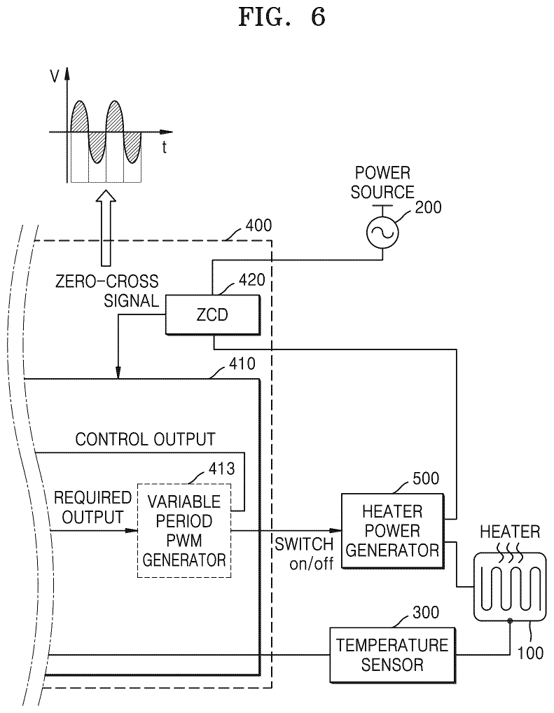

FIG. 5 is a diagram for describing a temperature control apparatus according to an embodiment of the present disclosure. FIG. 6 is a diagram for describing a zero-cross signal-based operation of a temperature control apparatus according to an embodiment of the present disclosure.

A temperature control apparatus 1 according to an embodiment of the disclosure is described below with reference to FIG. 5.

The temperature control apparatus 1 may include a heater 100, a power source 200, a temperature sensor 300, a controller 400, and a heater power switch 500.

The heater 100 may be heated when the power is supplied thereto. In an embodiment, the heater 100 may be formed of an arbitrary electro-resistive material.

The power source 200 may supply AC power to another component. The heater 100, the temperature sensor 300, the controller 400, and the heater power switch 500 may activate when receiving the power from the power source 200.

The heater power switch 500 receives a control signal from the controller 400 and supplies or blocks electric power to the heater 100. The heater power switch 500 may be a solid-state relay (SSR).

Although not shown in FIG. 5, the temperature control apparatus may further include a power conversion circuit that converts the power from the power source 200 and supplies the power to each component, e.g., a low dropout (LDO) circuit or a voltage regulator circuit.

The temperature sensor 300 may sense the temperature of the heater 100 and output a measured temperature value to another component. The controller 400 may control the temperature of the heater 100 by controlling the supply of power from the power source 200 to the heater 100 based on the measured temperature value transferred from the temperature sensor 300. The controller 400 may control the power supply to the heater 100 so that the heater 100 follows the set temperature.

The controller 400 may control the heater 100 so that the temperature of the heater 100 reaches the set temperature. The heater power switch 500 may start or stop the power supply to the heater 100, on receiving the control signal from the controller 400. According to the control signal sent from the controller 400, the heater power switch 500 may control the power supply with respect to the heater 100.

The controller 400 may include a processor 410, a zero-cross detector (ZCD) 420, and a memory 430. The controller 400 may control overall operations of the temperature control apparatus 1.

The controller 400 may analyze sensed result of the temperature sensor 300 and control post processes. For example, the controller 400 may control the power supplied to the heater 100 so that the heater 100 starts operating or stops operating, based on the measured temperature sensed by the temperature sensor 300. Based on the sensing result from the temperature sensor 300, the controller 400 may control the amount of power and the time of supplying power to the heater 100, so that the heater 100 may be heated to the set temperature or maintain at the set temperature.

The processor 410 is a component performing calculations, and the processor 410 may be implemented as an array of a plurality of logic gates or a combination of a universal microprocessor and the memory in which programs executable on the microprocessor are stored. In addition, one of ordinary skill in the art would appreciate that the processor 410 may be implemented as other types of hardware.

The ZCD 420 monitors an intensity of the AC voltage (or AC current) of the power source 200, and when a zero point where the intensity of the voltage (or current) becomes 0 is detected, the ZCD 420 outputs a zero-cross signal. The zero-cross signal may be transferred to a component such as the processor 410, etc. For convenience of description, it is described that the zero-cross signal is output when the voltage of the power source 200 is 0. However, the disclosure is not limited to the above example, and the temperature control apparatus and method according to the disclosure may have an embodiment in which the zero-cross signal is output when the current is 0.

FIG. 6 shows a graph for illustrating the zero-cross signal generated by the ZCD 420. Referring to FIG. 6, the ZCD 420 may output the zero-cross signal to the processor 410 when an intensity of the AC voltage V of the power source 200 is 0.

The processor 410 may control the heater 100 by outputting the control signal to the heater power switch 500 when receiving the zero-cross signal from the ZCD 420. In the above way, the power supply of the heater power switch 500 may start or stop according to the zero point where the intensity of the AC voltage V of the power source 200 becomes 0, and thus, noise caused by the radio frequency/high-voltage may not occur. Thus, the issues of the phase angle control may be addressed, and the apparatus may be used without any limitation in the capacity or characteristic of the load.

Referring to the graph shown in FIG. 6, a gap between the zero-cross signal and the zero-cross signal generated when the AC voltage V is 0 is 0.5 times longer than the period of the AC voltage V. In addition, the time period between the zero-cross signal and the zero-cross signal may be referred to as one control period, or the time 0.5 times longer than the period of the AC voltage V may be referred to as one control period. Hereinafter, for convenience of description, 0.5 period of the AC voltage will be referred to as one control period or one cycle.

The memory 430 is hardware for storing various data processed in the temperature control apparatus 1 and may store data processed and to be processed by the controller 400. The memory 430 may include a storage medium of at least one type of a flash memory type, a hard disk type, a multimedia card micro type, a card type memory (e.g., an SD or XD memory, etc.), random access memory (RAM), a static RAM (SRAM), a read-only memory (ROM), an electrically erasable programmable ROM (EEPROM), a programmable (PROM), a magnetic memory, a magnetic disk, and an optical disk.

The processor 410 may perform operations required for PID control, output integration control, variable period PWM generation control, etc. Referring to FIG. 5, the processor 410 may include a PID controller 411, an output integrator 412, and a variable period PWM generator 413. The PID controller 411, the output integrator 412, and the variable period PWM generator 413 may be software implemented as algorithms due to the operation of the processor 410. In another example, at least some of the PID controller 411, the output integrator 412, and the variable period PWM generator 413 may be provided as hardware separate from the processor 410.

The control period may be repeated once whenever the zero-cross signal is detected. That is, the control period may denote a time period from a time when receiving a zero-cross signal to a time when receiving next zero-cross signal. The processor 410 may determine whether the status of supplying the power to the heater 100 is changed when receiving the zero-cross signal from the ZCD 420.

The PID controller 411 calculates a temperature difference between the measure temperature and the set temperature, and may calculate and output a PID control value based on the temperature difference.

The processor 410 may calculate a required output that is a ratio of the output required for the heater 100 to reach the temperature with respect to the maximum output from the power source 200.

The output integrator 412 may calculate the required output value by integrating insufficient outputs generated in the previous control period, based on the PID control value output from the PID controller 411. The insufficient output may be calculated as a difference between the required output calculated in the previous control period and the control output.

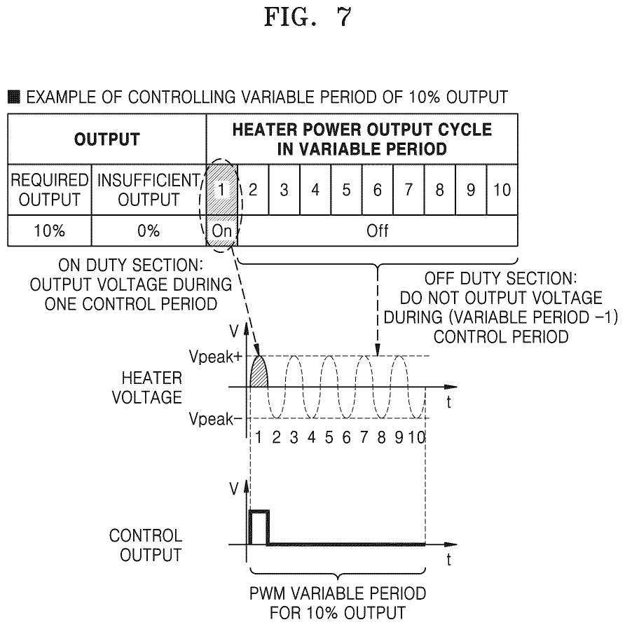

The variable period PWM generator 413 calculates the control output to be applied to the heater 100 and calculates the variable period based on the calculated control output, based on the required output value output from the output integrator 412. The calculation of the control output and the variable period is described in detail later with reference to FIGS. 7 to 9.

A value of “required output-control output” is calculated as the insufficient output value and may be stored in the memory 430.

As described above, the controller 400 may perform feedback control with respect to the temperature of the heater 100 through a closed loop temperature control consisting of “sensing zero-cross signal→detecting measurement temperature→PID control calculation→output integration control calculation→required output calculation→control output and variable period calculation→control signal output→insufficient output calculation→sensing zero-cross signal→detecting measurement temperature . . . ”.

The method of controlling the heater 100 through the PID control, the output integration control, and the variable period PWM control algorithms is described in detail later with reference to FIG. 11.

FIGS. 7 to 9 are tables and graphs for describing the method of calculating the variable period and the control output in the temperature control method according to an embodiment of the disclosure.

The temperature control method according to an embodiment of the disclosure may be implemented by various components in the temperature control apparatus 1 described above with reference to FIGS. 5 and 6. The description of the required configuration in the temperature control method uses the description of the components in the temperature control apparatus 1 described with reference to FIGS. 5 and 6.

In the temperature control method according to the embodiment, the variable period denotes a time period required to control the heater 100. The variable period is integer multiple of one control period and may be expressed as ‘n-times’ or ‘n-cycle’. The number of times of required variable period may be calculated by the variable period PWM generation algorithm of the processor 410.

Referring to FIG. 7, the method of calculating the required output, the control output, and the variable period for controlling the heater with the output that is 10% of the maximum output is described below.

In the variable period, the power may be supplied to the heater during only one control period (On duty), and may not be supplied to the heater until the variable period is ended during the remaining control period (Off duty). For example, when the variable period is 10 times, the voltage is output during one control period (On duty) and may not be output during nine control periods (Off duty). That is, the voltage is applied to the heater during only 10% of control period in the variable period, and thus, 10% output may be provided to the heater during one variable period.

The total number of times of repeating the control period during the variable period may be referred to as a variable period value. When 10% of output is required, the variable period value is set as 10, the voltage is output for one control period (on duty) and is not output for nine control periods, that is, the variable period value-1 (off duty), so as to achieve the required output. In other words, after outputting the voltage for one control period (on duty), the voltage is not output for integer times (=9) the number of control periods (off duty), and then, the required output may be achieved and the insufficient output does not occur.

Because the required output is 10% and the control output is 10%, the insufficient output calculated by subtracting the control output (%) from the required output (%) becomes 0%. Like in the example, when the insufficient output is 0%, 0% is integrated with the required output in a next variable period, and thus, the integration control may not be substantially performed.

As such, it may be identified that the integration control is not necessary when the control periods, in which the voltage is not output, is an integer multiple in order to achieve the output.

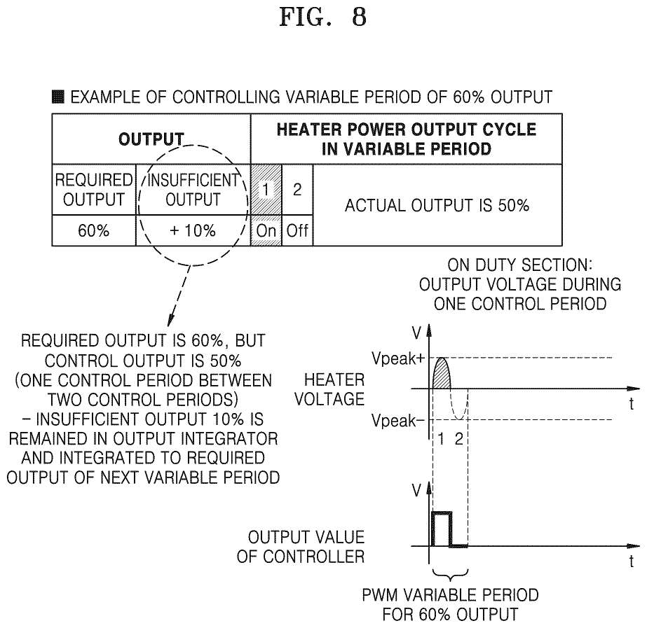

Referring to FIG. 8, the method of calculating the required output, the control output, and the variable period for controlling the heater with the output that is 60% of the maximum output is described below.

When the output is 60% of the maximum output, like in the case in which the output is 10% of the maximum output, the output of the voltage supplied to the heater during the variable period may be supplied only one control period (on duty) and may not be provided during the remaining variable period (off duty). However, in this case, the required variable period value is 5/3 that is a reciprocal of 0.5, and thus, the required output may be achieved provided that the voltage is not output during 2/3 control period that is (variable period value-1) number of times of control periods. However, unlike the phase angle control, the control based on the zero-cross signal is executed only when the AC voltage is 0, and the voltage may not be turned on/off with the control period that is not the integer multiple. That is, in the control based on the zero-cross signal according to the related art, the power supplied to the heater may be controlled to be the output (10%, 20%, 50%, etc.) where the reciprocal of the required output (%) is an integer, and thus, the intensity of power supplied to the heater is restricted and the precision in control may degrade.

To address the above issue, according to the control method of the embodiment, an output of 50% that is adjacent to the required output 60% may be set as the control output. Because the reciprocal of 50% is 2, that is, an integer, the output of 50% may be output in the zero-cross type.

The variable period value may be calculated as a reciprocal of the control output. In the example, because the control output is 50% (=0.5), the variable period value may be 2. That is, in order to achieve the control output of 50%, the variable period value may be determined as 2, the voltage is output during one control period (on duty), and the voltage may not be output during the remaining one control period calculated by (variable period value-1) (off duty). In this case, because the insufficient output (%)=required output (%)−control output (%), the insufficient output is 10%. The insufficient output of 10% is stored in the memory 430, and in the next variable period that is repeated after finishing the current variable period, the insufficient output may be integrated to the new required output through the output integration algorithm. The new required output may be calculated by adding the insufficient output and the PID control value.

Through repetition of the above processes, it is possible to precisely control the temperature of the heater even when an integer % output is required as well as a decimal output, without being bound by whether the reciprocal of the required output (%) is an integer, even though the control is zero-cross based.

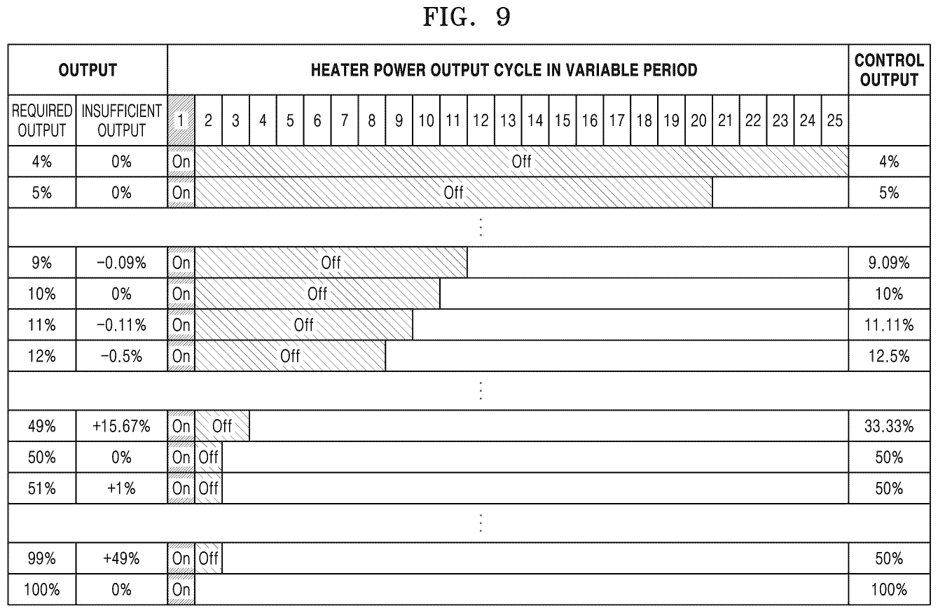

FIG. 9 is a table for executing a variable period control according to an embodiment of the disclosure.

In order to perform the output integration control according to the embodiment of the disclosure, a control output and an insufficient output are necessary for each required output.

Because the control output is an output performed based on the zero-cross control, any value may be used provided that the reciprocal is an integer, but in order to reduce unnecessary error, a value that is as close to the required output as possible needs to be selected.

Referring to FIG. 9, when the reciprocal of the required output is an integer (e.g., 4%, 5%, 10%, 50%, and 100%), values of the control output and the required output are equal to each other, and insufficient output does not occur. In the above case, the integration control is not necessary, as described above.

Unlike the above example, when the reciprocal of the required output is not an integer (e.g., 9%, 11%, 12%, 49%, 51%, and 99%), the required output is selected as another value of which the reciprocal may be an integer multiple, and after that, the generated error may be integrated to the next control period and controlled.

For example, the control output may be a value obtained by rounding up a reciprocal of the required value and then reversing again. In another example, the control output may be a value that is the reciprocal of the required output raised and then reciprocated again. In another example, the control output may be a value that is the reciprocal of the required output discarded and then reciprocated again.

As described above, the control output and the insufficient output corresponding to the required output may be stored in the memory 430 in advance so as to be loaded and utilized when the processor 410 requires them. For example, the processor 410 may calculate and store control outputs, variable period values, and insufficient outputs corresponding to a plurality of required outputs in the memory 430, and may load them from the memory 430 as necessary to control the temperature of the heater. In another example, the memory 430 may store a table as to the control outputs, the variable period values, and insufficient outputs corresponding to various required outputs from the beginning, and the processor 410 may use the control outputs, the variable period values, and insufficient outputs stored in the table to control the temperature of the heater without calculating the above values. In another example, the control output and the insufficient output corresponding to the required output may be calculated and used by the processor 410 as necessary to control the temperature of the heater.

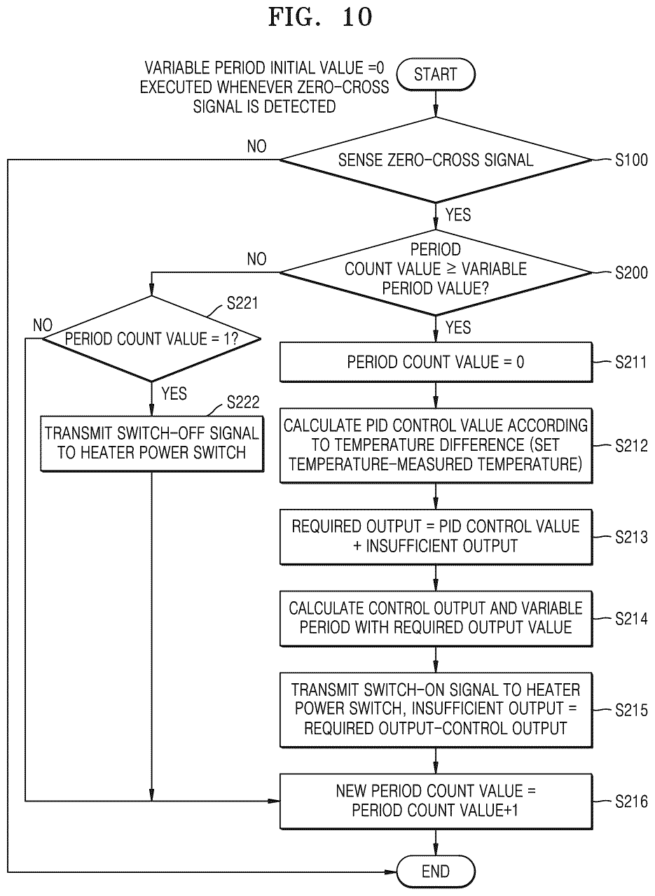

FIG. 10 is a flowchart for describing a temperature control method according to an embodiment of the present disclosure. To avoid redundant descriptions, descriptions about the same components as those described with reference to FIGS. 5 to 9 may be omitted.

The temperature control method according to the embodiment described with reference to the flowchart of FIG. 10 may be implemented by the components included in the temperature control apparatus 1 described above with reference to FIGS. 5 to 9, e.g., the processor 410, the memory 430, etc.

The temperature control method according to the embodiment may be executed at every control period and every 0.5 AC voltage period. When the zero-cross signal is not input, the temperature control method may not be executed.

The processor 410 may count how many times the control period has been repeated so far whenever one control period elapses, and store the value in the memory 430. Here, the value of the number of times that the control cycle is repeated may be referred to as a period count value. For example, when the variable period is 50 times, 1 control period proceeds every time the zero-cross signal is detected, and when the zero-cross signal is detected 50 times after the variable period is progressed, the period count value may be 50. The processor 410 may update the period count value whenever the zero-cross signal is detected from the ZCD 420.

In addition, the processor 410 may execute the temperature control method whenever receiving the zero-cross signal from the ZCD 420 (operation S100).

The processor 410 may compare the period count value with the variable period value when sensing the zero-cross signal (operation S200). The variable period value may be the total number of repetition of the control period while the variable period progresses. The initial value of the variable period may be 0.

In operation S200, when the period count value is equal to or greater than the variable period value, the processor 410 may consider that the variable period is finished and may start a new variable period.

In order to start a new period, the processor 410 may update the period count value as 0 (operation S211).

The processor 410 may calculate a temperature difference between the measurement temperature detected by the temperature sensor 300 and the set temperature, and may calculate the PID control value by performing a PID control based on the temperature difference (operation S212). Proportional parameters, integral parameters, and differential parameters required for PID control are values appropriately selected by those who skilled in the art, and may be calculated and applied through experimental/empirical methods.

The processor 410 may calculate a required output in consideration of the insufficient output accumulated in the previous variable period based on the PID control value (operation S213). The insufficient output and the required output may be determined as a ratio to the maximum output of the power source 200. The PID control value may be converted into an appropriate value so as to be summed up with the insufficient output.

The processor 410 may calculate the control output and the variable period value based on the required output calculated in operation S213 (operation S214). The control output may be determined as a value of which the reciprocal is an integer and close to the required value. For example, the control output may be a value obtained by rounding up, raising, or discarding a reciprocal of the required value and then reversing again. The variable period value may be a value obtained by rounding up, raising, or discarding the reciprocal of the required output. The variable period value may be a reciprocal of the control output.

When the value of the required output is a value of which the reciprocal is an integer, the control output may be determined to be equal to the required output.

The processor 410 transmits a switch-on signal to the heater power switch 500 for supplying power to the heater and may calculate the insufficient output (operation S215).

The insufficient output may be calculated as a value of “required output-control output”. When the value of the required output is a value of which the reciprocal is an integer, the insufficient output may be 0.

The processor 410 may store the insufficient output in the memory 430 and update the period count value to 1.

When the period count value is less than the variable period value, the processor 410 may determine whether the period count value is 1 (operation S221).

In operation S200, when the period count value is less than the variable period value, the processor 410 determines that is the variable period is progressing, and then, may determine whether the period count value is 1 (operation S221).

Because the control period is terminated for the first time when the period count value is 1 in operation S221, the processor 410 transmits a switch-off signal to the heater power switch 500 for stopping the power supply to the heater (operation S222), and stores a value obtained by adding 1 to the period count value as a new period count value in the memory 430 and finishes the control operation (operation S216).

Because the control period is progressing more than once when the period count value is not 1 in operation S221, the switch-off state in which the power supply to the heater is suspended has to be maintained, and thus, a value obtained by adding 1 to the period count value is stored as a new period count value in the memory 430 without performing any other operation and then the control operation may be finished (operation S216).

According to the control method as described above, the control output and the variable period are calculated according to the output required for first one control period and the power is supplied to the heater, and after that, in the second control period, the power supply to the heater is suspended. In addition, when the period count value is equal to the variable period value (=when the variable period is ended), the power supply blockage to the heater is maintained and the required output may be provided.

According to the temperature control apparatus and method of the embodiment, a certain variable period consists of a plurality number of times of control periods, and the power is supplied to the heater during only the first one control period, and during the remaining control periods, the power is not supplied to the heater and the variable period is finished. The power supply to the heater is fixedly performed only during one control period, and thus, the magnitude of the output is dependent upon the length and the number of times of the variable period. By repeating the above relatively simple turning-on/off, the heater may be controlled to the desired temperature by providing all the desired numerical outputs to the heater, and thus, the control precision may be improved, and moreover, device durability may be prevented from deteriorating due to radio frequency and noise and the reactive power does not occur, based on the zero-cross control.

Furthermore, it is obvious to those who skilled in the art that the temperature control method disclosed in the embodiment of the disclosure may be used in the same manner in the process of cooling the heater as well as heating the heater. For example, the above-described temperature control apparatus and method may be used in the same way in the control of a cooler of which the temperature decreases by receiving power.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A temperature control apparatus comprising:
a heater of which a temperature increases in response to receiving power;
a power source configured to supply alternating current (AC) power to the heater;
a temperature sensor configured to sense the temperature of the heater and output a measured temperature value; and
a controller configured to control the power supply to the heater so that the heater follows a set temperature profile,
wherein the controller is further configured to supply the power to the heater for first one control period in a variable period consisting of a plurality number of times of control periods (on duty), and stop the power supply to the heater during remaining control periods until the variable period is finished (off duty).

2. The temperature control apparatus of claim 1, wherein
the controller is further configured to calculate a required output that is a ratio of an output required for the temperature of the heater to reach the set temperature with respect to a maximum output of the power, and
a variable period value that is a total number of times that the control period is repeated during the variable period and is calculated as an integer obtained by rounding up a reciprocal of the required output.

3. The temperature control apparatus of claim 2, wherein the controller comprises:
a processor configured to perform calculations; and
a memory storing data,
and the processor is further configured to
calculate a reciprocal of the variable period value as the control output,
calculate a value obtained by subtracting the control output from the required output as an insufficient output, and
the memory stores the insufficient output, and
in a next variable period repeated after finishing the variable period, a new required output is calculated based on the insufficient output stored in the memory.

4. The temperature control apparatus of claim 3, wherein the processor is further configured to
calculate a PID control value based on a difference between the set temperature and a measured temperature, and
calculate a new required output by integrating the stored insufficient output based on the PID control value.

5. The temperature control apparatus of claim 3, wherein the processor is further configured to
calculate control outputs, variable period values, and insufficient outputs corresponding to a plurality of required outputs in advance and store the calculated values in the memory, and
load from the memory and use the control output, the variable period value, and the insufficient output corresponding to the required output that is required according to the repetition of the variable periods.

6. The temperature control apparatus of claim 1, wherein the controller comprises:
a zero-cross detector (ZCD) that outputs a zero-cross signal when an intensity of the AC voltage from the power source is 0; and
a processor configured to perform calculations,
the control period is determined as a time period from a time when receiving a zero-cross signal to a time when receiving next zero-cross signal, and
the processor is further configured to determine whether the power supply status with respect to the heater is changed when receiving the zero-cross signal from the ZCD.

7. The temperature control apparatus of claim 1, further comprising
a heater power switch configured to allow the supply of power or blocks the power supply to the heater in response to receiving a control signal from the controller,
wherein the heater power switch comprises a solid-state relay (SSR).

8. The temperature control apparatus of claim 1, wherein the control period is 0.5 times greater than a period of the AC voltage from the power source.

9. A temperature control apparatus comprising:
a cooler of which a temperature decreases in response to receiving power;
a power source configured to supply alternating current (AC) power to the cooler;
a temperature sensor configured to sense the temperature of the cooler and output a measured temperature value; and
a controller configured to control the power supply to the cooler so that the cooler follows a set temperature profile,
wherein the controller is further configured to supply the power to the cooler for first one control period in a variable period consisting of a plurality number of times of control periods (on duty), and stop the power supply to the cooler during remaining control periods (off duty), and
calculate a required output that is a ratio of an output required for the temperature of the cooler to reach the set temperature with respect to a maximum output of the power, wherein
the number of times of the control periods included in the variable period is calculated as an integer obtained by rounding up a reciprocal of the required output.

10. A temperature control method used by a temperature control apparatus to control a power supply to a heater during a variable period consisting of a plurality number of times of control periods, so that the heater follows a set temperature, the temperature control method comprising:
a period count step in which a period count value that is the number of times that the control period is repeated with a variable period value that is a total number of times that the control period is repeated during the variable period;
a period update step, in which the period count value is updated to 0 when the period count value is greater than or equal to the variable period value in the period count step; and
a switch-on step, in which a switch-on signal for supplying power to the heater is transmitted to a heater power switch after setting the period count value as 0 in the period update step.

11. The temperature control method of claim 10, further comprising a period ending step, in which a value obtained by adding 1 to the period count value after the switch-on step is stored as a new period count value.

12. The temperature control method of claim 10, further comprising:
an initial period determination step in which, when the period count value is less than the variable period value in the period counting step, it is determined whether the period count value is 1; and
a switch-off step in which, when the period count value is 1 in the initial period determination step, a switch-off signal for blocking the power supply to the heater is transmitted to the heater power switch.

13. The temperature control method of claim 12, further comprising
a period ending step, in which a value obtained by adding 1 to the period count value after the switch-off step is stored as a new period count value.

14. The temperature control method of claim 10, further comprising:
an initial period determination step in which, when the period count value is less than the variable period value in the period count step, it is determined whether the period count value is 1; and
a period ending step in which, when the period count value is not 1 in the initial period determination step, a value obtained by adding 1 to the period count value is stored as a new period count value.

15. The temperature control method of claim 10, further comprising:
a proportional-integral-differential control (PID) step in which a PID control value is calculated based on a difference between a measured temperature detected by a temperature sensor measuring the temperature of the heater and the set temperature, after updating the period count value to 0 in the period update step; and
a required output calculation step, in which the required output that is a ratio of an output required for the temperature of the heater to reach the set temperature with respect to a maximum output of the power source is calculated based on the PID control value calculated in the PID step.

16. The temperature control method of claim 15, further comprising a variable period/control output calculation step in which, based on the required output calculated in the required output calculation step, a value obtained by rounding up a reciprocal of the required output value is set as the control output and a value obtained by rounding up a reciprocal of the required output is set as the variable period value.

17. The temperature control method of claim 16, wherein
the temperature control apparatus further includes a memory for storing data, and
in the switch-on step, a value obtained by subtracting the control output from the required output is stored as an insufficient output in the memory.

18. The temperature control method of claim 10, further comprising:
a zero-cross signal sensing step in which a zero-cross signal indicating that a voltage of the power source is 0 is sensed,
wherein, when the zero-cross signal is sensed in the zero-cross signal sensing step, the period count step is executed.

19. The temperature control method of claim 17, wherein, when the period count value is updated to 0 in the period update step and a new variable period starts,
in the required output calculation step, a new required output value is calculated based on the insufficient output value and the PID control value provided that there is the insufficient output value stored in the memory in a previous variable period.
